(19) United States
(12) Patent Application Publication
(10) Pub. No.: US 2012/0103200 A1
(43) Pub. Date: May 3, 2012

(54) Electrical Steamer

(75) Inventors: Shu Sang CHEUNG, GUANGDONG PROVINCE (CN); Shu Wan CHEUNG, GUANGDONG PROVINCE (CN); Kwong Wai CHEUNG, GUANGDONG PROVINCE (CN)

(73) Assignee: Huiyang Allan Plastic & Electric Industries Co., Limited, Guangdong Province (CN)

(21) Appl. No.: 13/042,418

(22) Filed: Mar. 7, 2011

(30) Foreign Application Priority Data
Oct. 29, 2010 (CN) 201020588524.4

(51) Int. Cl. A47J 27/04

(52) U.S. Cl. 99/448

(57) ABSTRACT

An improved electrical steamer is provided. The electrical steamer includes a base unit and steaming bowls. The base unit includes a water tank for receiving water and a heating device for converting the water into steam. The steaming bowls are configured for holding food to be steamed. The heating device includes a steam generator capable of generating steam and spraying the steam to the steaming bowls from a plurality of directions. The electrical steamer generates steam faster by utilizing a general heater and the steam generator. The steam generator sprays steam quickly to the steaming bowls from bottom to top, circles the bowls with steam, thus original nutrition of the food can be kept better. The micro-controlled steam generator enables best cooking time and better taste of food.

### BACKGROUND OF THE INVENTION

The present disclosure relates to improvement of a new electrical steamer.

Refer to FIGS. 1-3, conventional electrical steamers consist of a base unit 11 with a water tank 121, steaming bowls 12, and a heater 131 received in the water tank 121. The water in the tank through the heater 131 and transforms into steam which goes into the steaming bowls 12 to cook food. It takes a long time to cook the food as heat is generated only though the heater and reaches the steaming bowls 12 at different strength from top to bottom of the steaming bowls 12. As a result, food is cooked at different temperature in the steaming bowls 12. What is more, heating waste is obvious and nutrition and taste of the food are not ideal.

### BRIEF SUMMARY OF THE INVENTION

The present disclosure discloses an improved electrical steamer providing an energy-efficient solution to the above stated technical problem with evenly-distributed steam and efficient cooking time.

The electrical steamer includes a base unit and steaming bowls. The base unit includes a water tank for receiving water and a heating device for converting the water into steam. The steaming bowls are configured for holding food to be steamed. The heating device includes a steam generator capable of generating steam and spraying the steam to the steaming bowls from a plurality of directions.

Comparing with the conventional electrical steamer, the present disclosure has the following advantages:

1. The electrical steamer generates steam faster by utilizing a general heater and the steam generator.

2. The steam generator sprays steam quickly to the steaming bowls from bottom to top, circles the steaming bowls with steam, thus original nutrition of the food can be kept better.

3. The micro-controlled steam generator enables best cooking time and better taste of food.

4. The steam generator emits steam into the steaming bowls in a dynamic manner so that food in the bottom, middle, and top steaming bowl can be heated evenly.

### BRIEF DESCRIPTION OF THE DRAWINGS

FIG. 1 is a schematic view of a general electrical steamer, the general electrical steamer includes a base unit.

FIG. 2 is a schematic view of the base unit of FIG. 1.

FIG. 3 is a schematic view of the base unit of FIG. 1, seen from another view.

FIG. 4 is a schematic view of an electrical steamer according to an exemplary embodiment, the electrical steamer includes a base unit which is shown in the sectional view.

FIG. 5 is a schematic view of the base unit of FIG. 4.

FIG. 6 is a schematic view of the base unit of FIG. 4, seen from another view, the base unit includes a steam generator and a heater.

FIG. 7 is cross-sectional view of the steam generator of FIG. 6.

FIG. 8 is a cross-sectional view of the heater of FIG. 6.

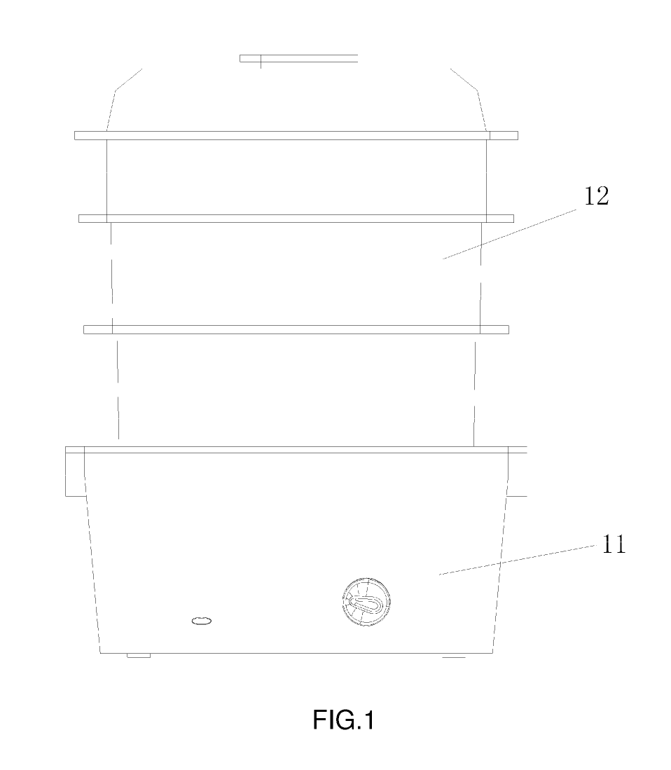

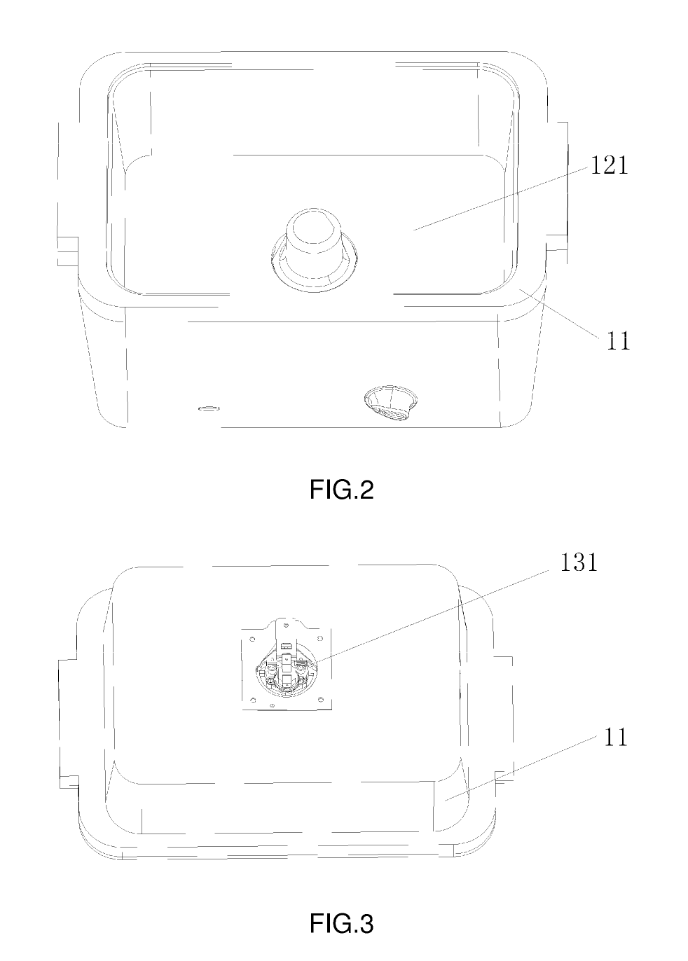

### DETAILED DESCRIPTION OF THE INVENTION

Embodiments of the present disclosure will now be described in detail below, with reference to the accompanying drawings.

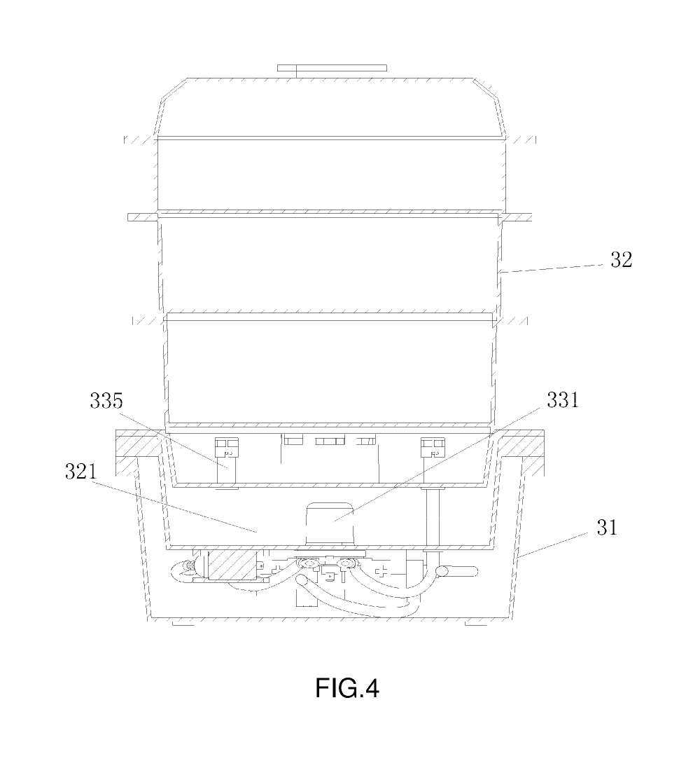

Referring to FIGS. 4-6, an electrical steamer with similar appearance to the conventional electrical steamer is illustrated according to an exemplary embodiment. The electric steamer includes a base unit 31 and a steaming bowls 32. The steaming bowls 32 are used for holding food to be cooked. The base unit 31 is used for generating steam. The steam flows through the steaming bowls 32 to heat the food from bottom to top. The base unit 31 includes a water tank 321 and a heating device 33 connected to the water tank 121 to heat the water in the water tank 321 into steam.

The heating devices 33 of this electrical steamer include two parts, a conventional heater 331 fixed in the middle of the water tank 321 and a steam generator 332. Referring to FIG. 8, the heater 331 includes a house fixed at the bottom of the water tank 321, and a resistance wire or substitute accommodated in the house. The heater 331 heats the water in the tank 321 directly to turn water into steam. The steam generator 332 produces steam more quickly to supplement the heater 331 and sprays steam to all the steaming bowls 32 to enable efficient cooking to keep better taste and nutrition of food.

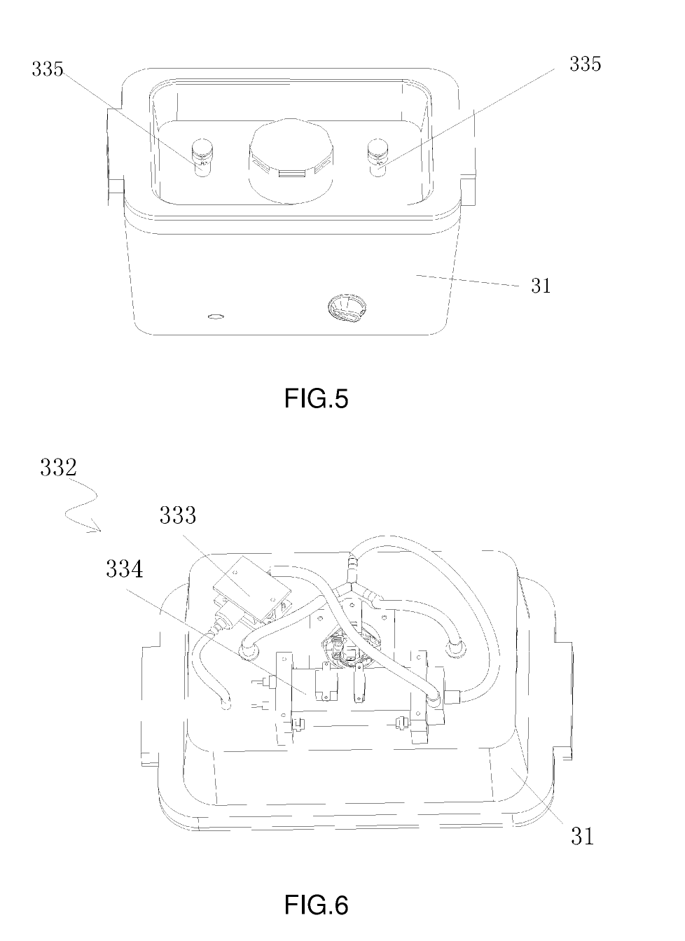

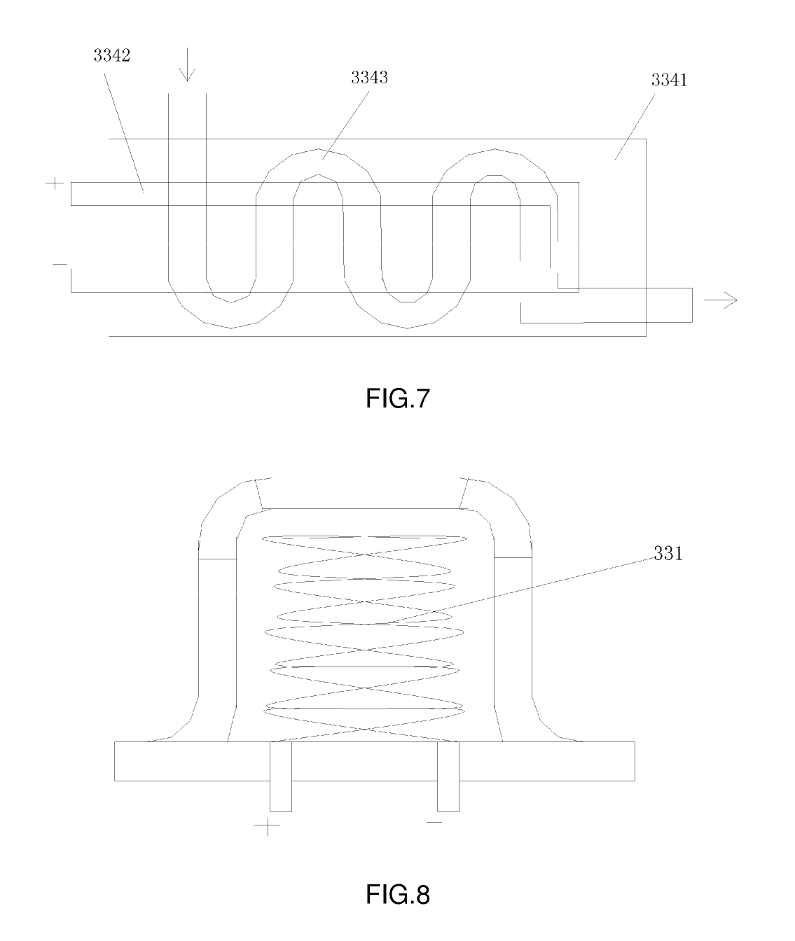

The steam generator 332 includes a pump 333 installed inside the base unit 31. As shown in FIG. 6, the inlet of the pump 333 connects to the water boiler 321 through a pipe to obtain water from the water tank 321. The outlet of the pump 333 connects to the inlet of the heater 334 through a pipe to supply the water to the heater 334. The outlet of the heater 334 connects to one or more steam-spraying pipes 335 protruding above the bottom of the water tank 321 through a pipe. As shown in FIG. 5, two steam-spraying pipes 335 are configured at both sides of the heater 331 in the water tank 321. The height of the pipes 335 should be over the rated maximum water level of the water tank 321. The heater 334 includes a casing 3341, inside which installed an electrical heating bar 3342 and a heat conductor 3343 linking the inlet and outlet of the heater 334. As shown in FIG. 7, the heat conductor 3343 coils around the heating bar 3342. In operation, water is pumped from the tank 321 to the heater 334, and then is turned into steam by the heater 334 and the heat conductor 3343. Then the generated steam sprays up into the steaming bowls 32 through spraying pipes 335.

The steam generator 332 operates under preset control. Experiments show that steam-spraying periodically or continuously from spraying pipes 335 perform better to cooking than no steam spraying. For instance, spray steam for 10 seconds, and then pause for 5 seconds. Cooking with such steam supply at intervals is more energy efficient. When the quantity of food is large and constant steam supply is needed, the steam generator can work without intervals, in a continuous manner.

To avoid over-heating and consequent possible safety concerns, thermal protection devices are installed on the electrical heating bar 3342 and the heater 331. In case the temperature of electrical heating bar 3342 or the heater 331 goes over the preset degree, the central controller will stop working of the part.

The above statement represents typical operation of the new electrical steamer. But the utility patent shall not be limited within the scope of the above detailed statement only. For technical personnel in this field, it is easy to work out similar product with some amendments such as to change the number of spraying pipes or mode of arrangement according to the size of the cooker. Even without a heater, steam generator alone can work independently in cooking. The idea of this new utility model and the above stated possibilities shall all be protected under this patent application. This utility patent should cover the scope of protection as stated in the application clauses.

What is claimed is:

1. An electrical steamer, comprising:
a base unit comprising a water tank for receiving water and a heating device for converting the water into steam; and
steaming bowls for holding food to be steamed;
wherein the heating device comprises a steam generator capable of generating steam and spraying the steam to the steaming bowls from a plurality of directions.

2. The electrical steamer of claim 1, wherein the steam generator comprises a pump and a heater, the inlet of the pump connects to the water tank through a pipe, and the outlet of the pump connects to the inlet of the heater through a pipe, the outlet of the heater connects to a plurality of steam-spraying pipes protruding above the bottom of the water boiler.

3. The electrical steamer of claim 2, wherein the height of the plurality of steam-spraying pipes is over the rated maximum water level of the water tank.

4. The electrical steamer of claim 3, wherein the heater comprises a casing, inside which installed with a single electrical heating bar or a plurality of electrical heating bars and a heat conductor connecting to the inlet and outlet of the heater, and a heat conducting pipe coiling around the plurality of the heating bars.

5. The electrical steamer of claim 4, wherein the heating device further comprises another heater configured in the middle of the water boiler.

6. The electrical steamer of claim 5, wherein the steam generator is configured with a micro-control device configured for instructing the steam generator to operate continuously or at intervals by preset, and a plurality of thermal protection devices setting on the steam generator and the heater respectively to avoid overheating.
